(19) United States
(12) Patent Application Publication
(10) Pub. No.: US 2020/0023601 A1
(43) Pub. Date: Jan. 23, 2020

(54) SCREW PRESS FOR SEPARATION OF LIQUIDS FROM BULK MATERIALS

(71) Applicant: US Farm Systems, Inc., Tulare, CA (US)

(72) Inventors: Rejean Houle, Tulare, CA (US); Brian G. Shoenhair, Tipton, CA (US)

(73) Assignee: US Farm Systems, Inc., Tulare, CA (US)

(21) Appl. No.: 16/041,626

(22) Filed: Jul. 20, 2018

(51) Int. Cl. B30B 9/12; B30B 9/18; B30B 9/26

(52) U.S. Cl. CPC B30B 9/121; B30B 9/18; B30B 9/125; B30B 9/122; B30B 9/262

(57) ABSTRACT

A screw press liquid separator includes an elongated housing having an inlet end and a discharge end, a screw cradle in the form of a sieve disposed within the housing and having a bulk material inlet disposed at the inlet end of the housing, at least one section of the screw cradle mechanically coupled to a vibrator motor, a screw formed on a shaft and disposed within the screw cradle, the screw extending from the inlet end of the screw cradle to a discharge end of the screw cradle, a motor rotatably coupled to the shaft, and pair of opposing discharge doors pivotally mounted to the discharge end of the housing and movable between an opened position and a closed position, the discharge doors driven to positions that maintain a substantially constant pressure on bulk material being driven by the screw towards the discharge end of the housing.

### BACKGROUND

The present invention relates to processing of bulk materials. More particularly, the present invention relates to separation of liquids from bulk materials and to a screw press arrangement for separating liquids from bulk materials such as livestock manure.

Numerous industries utilize compression devices such as screw press liquid separators to remove liquid from bulk materials such as wood chips, livestock manure, byproducts of food processing operations, or other fibrous materials. The screw press liquid separators are based on the principle of a screw rotating inside a cylindrical or conical cage, sometimes referred to as a screw cradle, that forces the bulk material from the inlet of the screw to an output in a manner that compresses the bulk material. The cage can be equipped with holes, usually conically drilled, or slots or bars arranged in such a fashion as to provide for drainage of the liquid that is squeezed from the bulk material.

The various uses of screw press liquid separators involve a number of mechanisms for creating pressure between the chamber and the shaft bearing flights. The inner diameter of the chamber may be cylindrical, conical, or may contain restricted areas. All of these features together with variations in the diameter of the shaft or diameters of the flutes on the shaft can produce changes in the pressure exerted on the wood chips or other material being treated in the screw press liquid separator. The chamber of the plug screw feeder may be comprised of bars, screens or be solid depending upon whether the screw press liquid separator is being used to drive off excess water from materials such as livestock manure or being used to refine materials such as wood chips or both remove excess fluid and refine the materials. In various applications the pressure and throughput are controlled by the voids if any in the chamber, the restrictions in the chamber, the shaping of the shaft or flutes and the torque applied to the screw feeder. Numerous examples of screw press liquid separators are known in the art.

U.S. Pat. No. 5,515,776 discloses a worm screw press having drainage perforations in the press jacket. The size of the shaft for the worm screw increases in cross-sectional area in the flow direction of the drained liquid.

U.S. Pat. No. 7,357,074 is directed to a screw press with a conical dewatering housing with a plurality of perforations for the drainage of water from bulk solids compressed in the press. A perforated casing or jacket is used.

U.S. Pat. No. 3,394,649 discloses a worm press used for the dewatering of sludges or cellulose pulp suspensions and comprises a hollow worm shaft having apertures at the end of the pressure zone. Through these bores still further liquid can be drained into the hollow shaft, this liquid draining inside the shaft in a direction opposite to the conveyance direction.

United States Published Patent Application 2016/0176141 is directed to a screw press having two opposing discharge doors that are pivotally mounted to the discharge end of the housing and are movable within a volume defined by the first and second discharge guides. The discharge doors are biased towards closure against the discharge end of the housing. Paddles are affixed to and radially extend from the shaft at a position beyond an arc defined by pivotal motion of the discharge doors.

These prior-art worm screw configurations appear to operate for their intended purposes. There is room for improvement of a screw press used for separation of liquids from bulk materials.

### BRIEF DESCRIPTION

According to one aspect of the present invention a screw press liquid separator includes an elongated housing having an inlet end and a discharge end, a screw cradle in the form of a sieve disposed within the housing having a material inlet disposed at the inlet end of the housing, a screw formed on a shaft and disposed within the screw cradle, a motor rotatably coupled to the shaft, the screw extending from the inlet end of the screw cradle to a discharge end of the screw cradle, a pair of opposing discharge doors pivotally mounted to the discharge end of the housing and movable within a volume defined by the first and second discharge guides, the discharge doors driven to positions that maintain a substantially constant pressure on bulk material being driven by the screw towards the discharge end of the housing.

According to an aspect of the invention, the positions of the discharge doors are controlled by fluid under pressure, the pressure of the fluid controlled by a feedback loop that acts to maintain current drawn by the motor at a substantially constant value.

According to an aspect of the invention, a section of the screw cradle mechanically coupled to the vibrator motor is vibrationally isolated from other sections of the screw cradle.

According to an aspect of the invention, a wear bushing is mounted on the shaft at a location between a discharge end of the screw and the discharge end of the screw press, the diameter of the wear bushing increasing towards the discharge end of the screw press.

### BRIEF DESCRIPTION OF THE DRAWING FIGURES

The invention will be explained in more detail in the following with reference to embodiments and to the drawing in which are shown:

FIG. 1A is a side view of an illustrative screw press in accordance with an aspect of the present invention;

FIG. 1B is a side view of the screw press of FIG. 1A with the covers for the screw cradle and shaft coupling removed;

FIG. 2A is a top view of the screw press of FIG. 1A;

FIG. 2B is a side cross-sectional view of the screw press of FIG. 1A taken through section line B-B;

FIG. 2C is a cross-sectional view of the wear bushing mounted towards a discharge end of the shaft;

FIG. 3A is a top view of the screw press of FIG. 1A showing discharge doors in a partially opened position;

FIG. 3B is a top view of the screw press of FIG. 1A showing discharge doors in a closed opened position;

FIG. 4A is a side view of the screw cradle of the screw press of FIG. 1A;

FIG. 4B is a cross sectional view along one of the major ribs of the screw cradle;

FIG. 4C is a magnified view of a portion of the cross sectional view of the screw cradle of FIG. 4B;

FIG. 5 is a side view of the screw cradle of the screw press of FIG. 1A where the two parts have been assembled to one another;

FIG. 6 is a block diagram of a control system for a liquid separating screw press in accordance with one aspect of the invention; and

FIG. 7 is a flow diagram showing an illustrative process for controlling pressure of the bulk material within a liquid separating screw press in accordance with one aspect of the invention.

### DETAILED DESCRIPTION

Persons of ordinary skill in the art will realize that the following description of the present invention is illustrative only and not in any way limiting. Other embodiments of the invention will readily suggest themselves to such skilled persons.

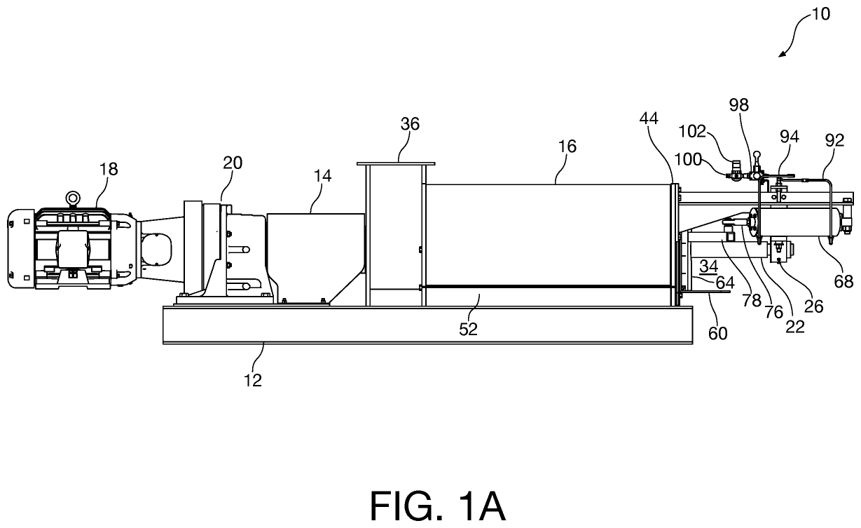

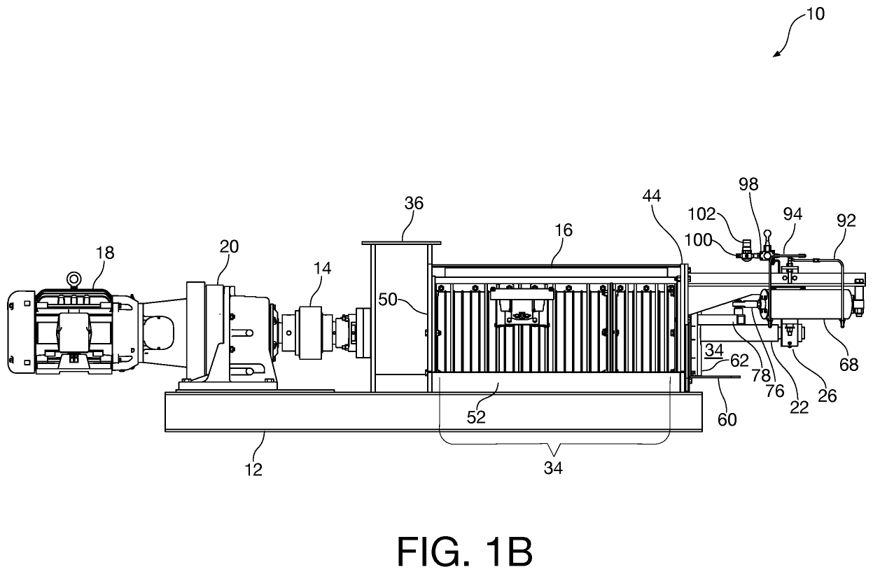

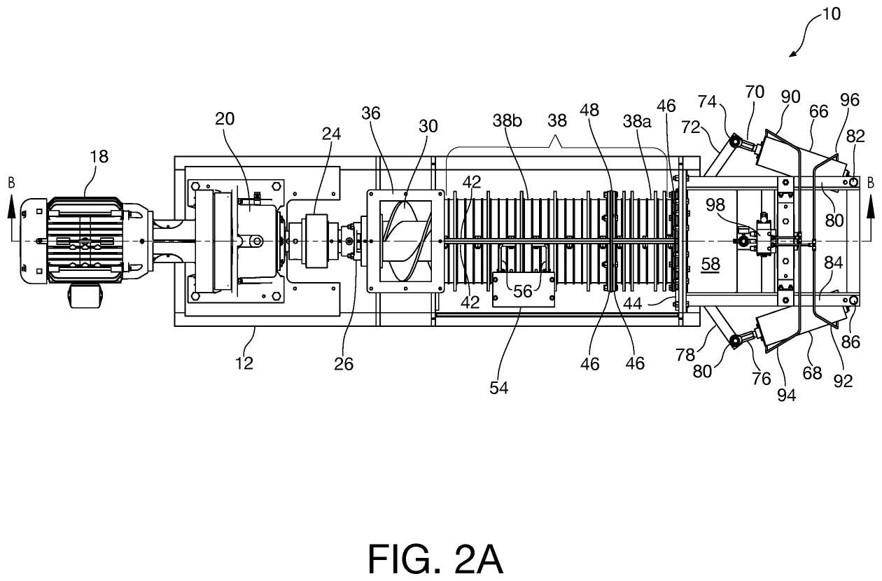

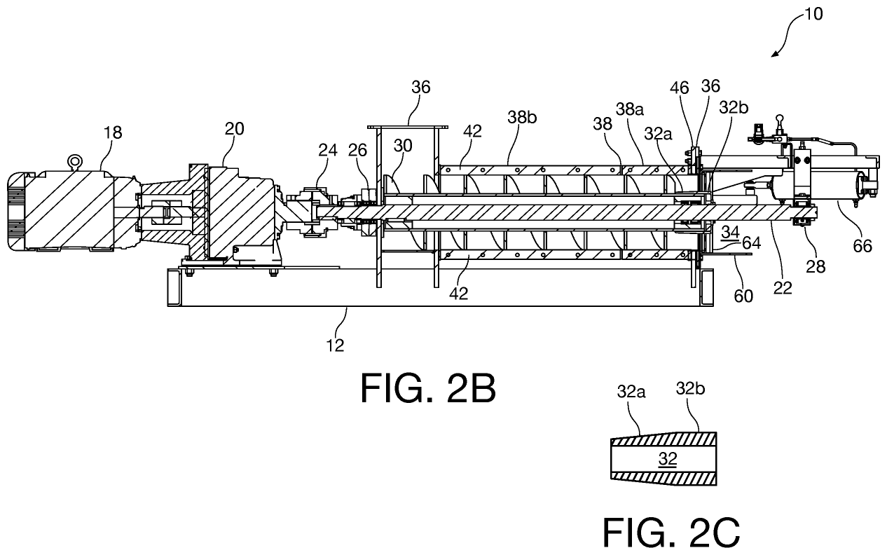

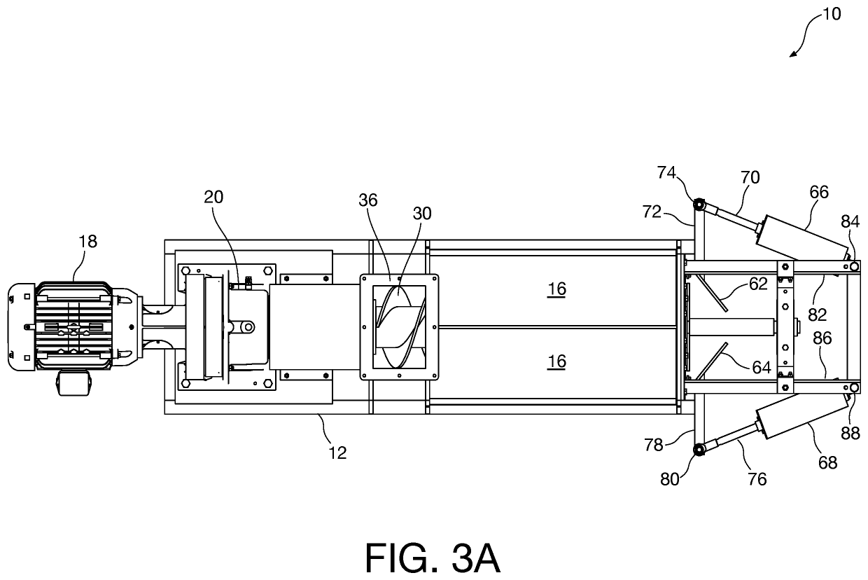

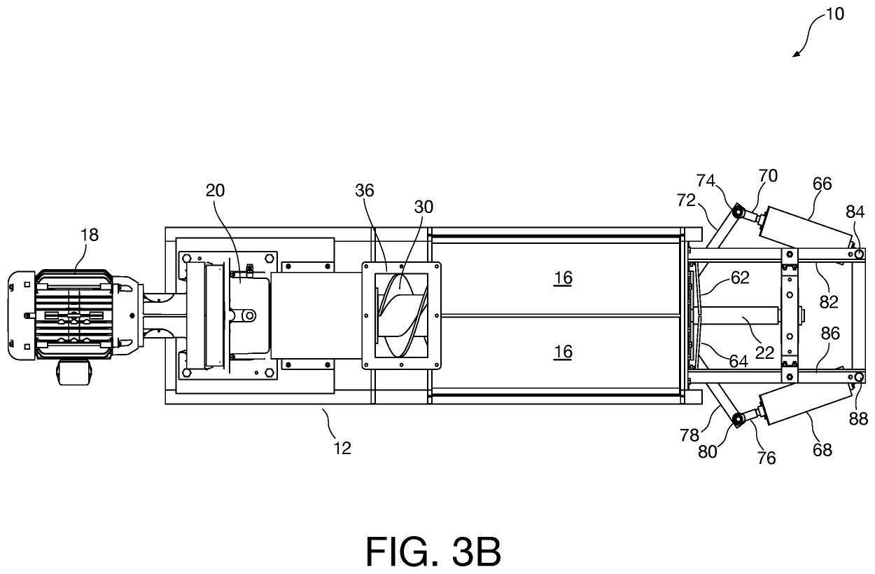

Attention is now drawn to FIGS. 1A, 1B, 2A, 2B, 3A, and 3B. FIGS. 1A and 1B are, respectively, side views of a liquid separating screw press 10. FIGS. 2A and 2B are, respectively, a top view of the screw press of FIG. 1A, and a side cross-sectional view of the screw press of FIG. 1A taken through section line B-B. FIGS. 3A and 3B are included to show the discharge doors in closed and partially opened positions respectively. Identical reference numerals are used in all of FIGS. 1A, 1B, 2A, 2B, 3A, and 3B to identify the same elements depicted in each of these drawing figures.

The screw press 10 is mounted on a base such as a frame 12, which may be formed, for example, from a steel I-beam. FIG. 1B shows the liquid separating screw press 10 with covers 14 and 16 removed.

The screw press 10 is driven by a motor 18, which in one exemplary embodiment is a 15 HP, 1800 rpm electric motor. The motor 18 is coupled to a reducer gear assembly 20 that turns a shaft 22 through a coupler 24. In the embodiment depicted in these drawing figures, the reducer gear assembly 20 reduces the rotational speed delivered to the shaft 22 to 20 rpm. Shaft rotational speeds between about 15 rpm and about 50 rpm would be typical for different embodiments of the present invention although lower speeds and higher speeds are possible depending on the dimensions of the screw press 10 as well as the nature of the bulk material being processed. The end of the shaft 22 closest to the coupler 24 is supported through a liquid seal 26. A distal end of the shaft 22 is supported by a bearing 28.

A screw 30 (seen in FIGS. 2A, 2B, 3A, and 3B) is formed on the shaft 22. The length of the screw 30 is typically between about 4 feet to about 8 feet more or less. Persons of ordinary skill in the art will appreciate that a screw press according to the principles of the present invention can be designed having other screw lengths.

A wear bushing 32 is mounted on the shaft 22 proximate to the discharge end 34 of the screw press 10 past the end of the screw 30. A cross-sectional view of a typical wear bushing 32 in accordance with this aspect of the invention is shown in FIG. 2C. As presently preferred, the wear bushing 32 includes a conical section 32a having a diameter that increases over a distance of about 3 to about 4 inches at an angle of between about 1° and about 5°, followed by a cylindrical section 32b having a constant diameter along a length of about 2 inches. The conical wear bushing 32 is a wear part that may be made from, for example, a machined or cast wear resistant alloy steel and may be heat treated or laser clad. The wear bushing 32 increases pressure exerted on the bulk material and protects the shaft 22 from wear.

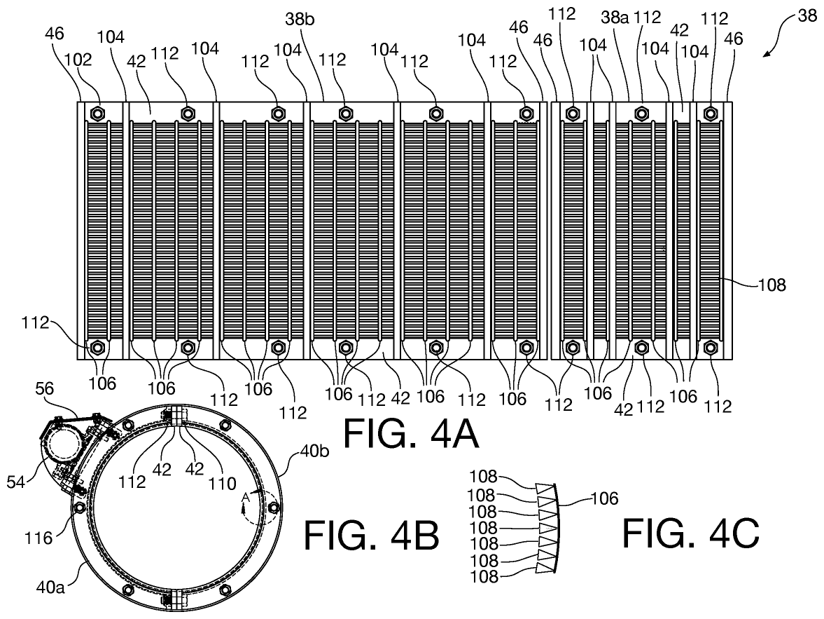

The driven end of the screw 30 communicates with an inlet hopper 36 into which the bulk material from which the liquid is to be separated is introduced. At the right side of the hopper 36 the screw is disposed within a screw cradle 38. In the illustrative embodiment shown in FIG. 2B, the screw cradle 38 consists of two sections 38a and 38b. Each of sections 38a and 38b is shown formed as two clamshell halves 40a and 40b that are shown bolted together at edge flanges 42 in the cross-sectional diagram of FIG. 4B.

Section 38a of the screw cradle 38 is fixedly mounted to a vertical member 44 of the frame at its right side by, for example, nuts and bolts passed through end flanges 46 as shown in FIG. 2B. The right end of section 38b of the screw cradle 38 is fastened (e.g., bolted) to section 38a at end flanges 46 through a vibration isolation gasket 48 formed from a resilient material such as gum rubber. In one embodiment of the invention, a gum rubber vibration isolation gasket 48 has an uncompressed thickness of about 0.25 inches.

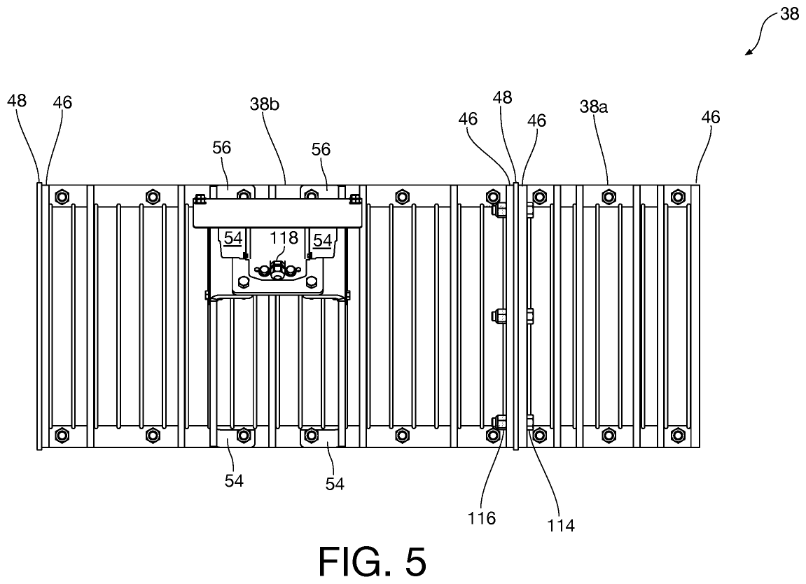

The left end of the section 38a of the screw cradle 38 is also mounted at an end flange 46 to a vertical member 50 of the frame 12 through a similar vibration isolation gasket 48, the view of which is obscured in FIG. 2B by the top border of the inlet hopper 36 (the end flange 46 and the vibration isolation gasket 48 at the left-hand end of screw cradle section is shown in FIG. 5). In some embodiments of the invention, the screw cradle 38 may include only section 38b, the left and right ends of which are mounted at end flanges 46 to vertical members 44 and 50 of the frame 12 through the above-described vibration isolation gaskets 48.

The inlet hopper 36 may be sized differently for different applications of the screw press of the present invention depending on, for example, the nature of the bulk material being processed. A drain pan (shown in side view at reference numeral 52 in FIG. 1A) is disposed below the screw cradle 38 to catch and drain liquid removed from the bulk material by the screw press 10.

The section 38b of the screw cradle 38 is vibrated by at least one vibrator motor 54 mounted to its outside surface by, for example, brackets 56 as shown in FIG. 2A. Applying vibrational energy to the section 38b of the screw cradle 38 provides a significant advantage in the removal of liquid from the bulk material. The screw cradle 38 will be shown and described in more detail with reference to FIGS. 4A, 4B, 4C and 5.

An upper guide plate 58 (shown in FIG. 2A) and a lower guide plate 60 (shown in FIGS. 1A and 1B) are positioned at the top and bottom, respectively, of the discharge end of the screw press 10. As shown in FIGS. 3A and 3B, an opposed pair of discharge doors 62 and 64 are pivotally mounted to the sides of the discharge end of the screw press 10. FIG. 3A shows the discharge doors 62 and 64 in a partially opened position and FIG. 3B shows the discharge doors 62 and 64 in a closed position.

According to another aspect of the present invention, pressure of the bulk material being processed in the screw press 10 is regulated by applying force towards closure to the discharge doors 62 and 64. The force is applied to the discharge door 62 is controlled by, for example, a pneumatic ram 66 and the amount of force applied to the discharge door 64 is controlled by a pneumatic ram 68. The piston 70 of pneumatic ram 66 is coupled to a control arm 72 at pivot 74 and the piston 76 of pneumatic ram 68 is coupled to a control arm 78 at pivot 80. Control arm 72 is pivotally mounted to discharge door 62 and control arm 78 is pivotally mounted to discharge door 64. The back end of pneumatic ram 66 is coupled to a support member 82 extending from the frame 12 at pivot point 84 and the back end of pneumatic ram 68 is coupled to a support member 86 extending from the frame 12 at pivot point 88. Persons of ordinary skill in the art will appreciate that the present invention contemplates use of fluids other than a gas, as well as other means such as electromagnetic force, to actuate the ram.

The amount of force applied to the discharge doors 62 and 64 is controlled by a pair of air control lines connected to each of pneumatic rams 66 and 68. Air control lines 90 and 92 are shown connected to pneumatic ram 66 in FIG. 1A. Pressurized air directed into control line 90 extends the piston 70 out of pneumatic ram 66 and pressurized air directed into control line 92 retracts the piston 70 back into pneumatic ram 66. The operation of discharge door 64 is similarly controlled by air control lines 94 and 96, which may be seen in FIG. 2A. Air control lines 90 and 94 are coupled together to bleed valve 98 as are air control lines 92 and 96. Bleed valve 98 allows the air pressure to be discharged from pneumatic rams 66 and 68. Air is supplied through input fitting 100 and is passed through pressure regulator 102. Pressure regulator 102 is controlled to maintain a substantially constant current drawn by the motor 18.

The amount of force applied to discharge doors 62 and 64 by pneumatic rams 66 and 68, respectively, is controlled to maintain a desired pressure on the bulk material being forced through screw press 10 by the screw 30. In accordance with one aspect of the present invention, the amount of current drawn by the motor 18 is monitored. The current drawn by motor 18 varies as a function of the pressure on the bulk material being forced through screw press 10 by the screw 30 which constitutes the load on motor 18. If the pressure on the bulk material being forced through screw press 10 by the screw 30 decreases, the motor current will decrease and if the pressure on the bulk material being forced through screw press 10 by the screw 30 increases, the motor current will increase. The current drawn by the motor 18 is sensed and the motor current is maintained at a constant value by regulating the air pressure provided to pneumatic rams 66 and 68 to position the doors 62 and 64 to control the pressure on the bulk material being forced through screw press 10 by the screw 30.

Referring now to FIGS. 4A, 4B, 4C and 5, according to one particular embodiment of the present invention, the screw cradle 38 is formed as a sieve. In an illustrative embodiment, the screw cradle 38 is formed in two sections, 38a and 38b. Each of screw cradle sections 38a and 38b is formed from two semi-cylindrical segments and each includes end flanges 46, major ribs 104 and minor ribs 106. A representative pair of segments is shown at one of the major ribs designated as 94a and 94b in FIG. 4B. In one presently contemplated embodiment, the outside diameter of the auger may be about 12 inches. The nominal ID of the screen in this embodiment is about 12.020. In any embodiment, the tolerance should be such as to avoid jamming the auger without allowing the bulk material to bypass the auger.

Spaced apart metal bars 108 running in a direction parallel to the shaft 22 that carries the screw 30 form the slot sieve portion of the screw cradle 38. FIG. 4C shows a magnified portion of an end view of the construction of the sieve, in which spaced apart bars 108 are shown in end view mounted to minor ribs (one of which is shown at reference numeral 106 in FIG. 4C) by, for example spot welding. Only one of the bars 108 is identified in FIG. 4A in order to avoid overcomplicating the drawing figures, and the bars 108 are omitted from FIG. 5 for simplicity sake. In a presently contemplated illustrative example, the bar spacing 108 is such that the bars are about three to about four times the width of the slots. The spacing of the bars may be tailored for the particular bulk material to be processed.

FIG. 5 shows sections 38a and 38b connected together at mating end flanges 46 using bolts (one of which is identified at reference numeral 114) and nuts (one of which is identified at reference numeral 116). One such nut 116 is also indicated at reference numeral 116 in FIG. 4C. Persons of ordinary skill in the art will appreciate that the relative lengths of sections 38a and 38b are not critical in any particular design. As previously noted, section 38b to which the vibrator motor 40 is coupled is vibrationally isolated from section 38a by a vibration isolation gasket 48 formed from a material such as gum rubber. In one illustrative embodiment, that gasket has an uncompressed thickness of about 0.25 inches. A similar gasket 48 is shown to the left of end flange 92 of section 38b in FIG. 5, where section 38b will be mounted to the screw press at the right side of the inlet hopper 36 shown in FIGS. 1A through 3B. Persons of ordinary skill in the art will appreciate that the section 38b may run the entire length of the screw cradle 38.

The two clamshell halves 40a and 40b that form each of screw cradle sections 38a and 38b are fastened together, and may be, for example, bolted together along edge flanges 46 using bolts 110 and nuts 112 (nuts along the top and bottom edge flanges 42 of sections 38a and 38b are indicated at reference numerals 112 in FIG. 4A). FIG. 2A also shows the screw cradle segments and the screw cradle parts 38a and 38b bolted together at edge flanges 42 and end flanges 46, respectively, and also shows the right-hand end of section 38a bolted to a sidewall 44 of the frame 12. A side view of the vibrator motor 54 and motor mounts 56 are also shown mounted to section 38b in FIG. 4B, while a top view of the vibrator motor 54 and motor mounts 56 are shown mounted to section 38b in FIG. 5. FIG. 5 also shows an electrical compression fitting connector 118 for supplying power to the vibrator motor 54.

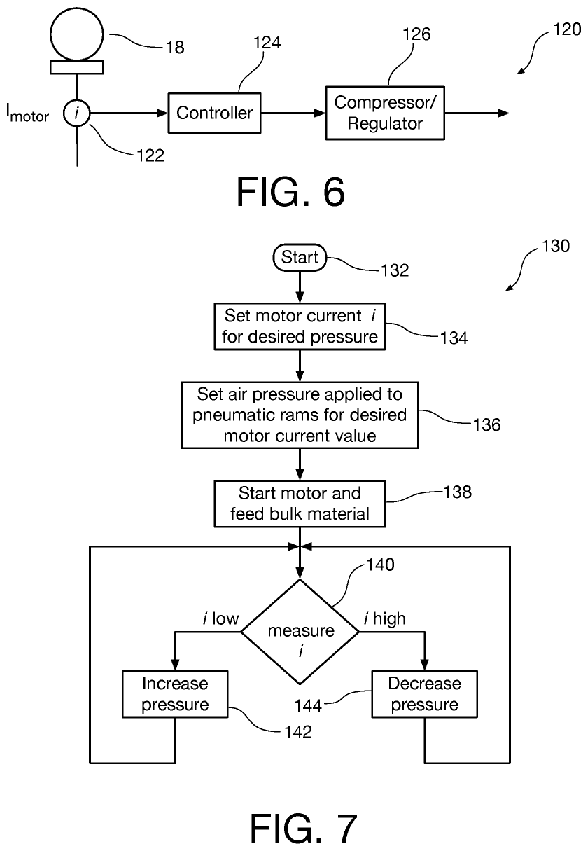

Referring now to FIG. 6, a block diagram shows a typical control system 120 for a liquid separating screw press in accordance with one aspect of the invention. The control system 120 uses a current sensor 122 to measure the current drawn by the motor 18. A signal representing the current drawn by the motor 18 is provided to controller 124. An output signal from controller 122 drives compressor 116 to produce a value of air pressure to drive the pneumatic rams to position the discharge doors 62 and 64 of the screw press to maintain a constant predetermined value of current drawn by the motor 18.

Referring now to FIG. 7, a flow diagram shows an illustrative process 130 for controlling pressure of the bulk material within a liquid separating screw press in accordance with one aspect of the invention. The process begins at reference numeral 132.

At reference numeral 134 the motor current i is set to provide a desired pressure to drive the pneumatic rams to position the discharge doors 62 and 64 of the screw press to exert a desired pressure on the bulk material being driven through the screw press. At reference numeral 136 the desired air pressure is applied to the pneumatic rams and at reference numeral 138 the motor is started, the vibrator motor is started, and bulk material is fed into the screw press.

At reference numeral 140 the current being drawn by the motor is measured. If the measured motor current is below the set current i, at reference numeral 142 the pressure is increased. If the measured motor current is above the set current i, at reference numeral 144 the pressure is decreased. The process indicated in FIG. 7 may be continuous or may be performed at selected time intervals.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

1. A screw press liquid separator comprising:
an elongated housing having an inlet end and a discharge end:
a screw cradle in the form of a cylindrical sieve disposed within the housing and having a bulk material inlet disposed at the inlet end of the housing;
a screw formed on a shaft and disposed within the screw cradle, the screw extending from the inlet end of the screw cradle to a discharge end of the screw cradle;
a motor rotatably coupled to the shaft; and
a pair of opposing discharge doors pivotally mounted to the discharge end of the housing and movable between an opened position and a closed position, the discharge doors driven to positions that maintain a substantially constant pressure on bulk material being driven by the screw towards the discharge end of the housing.

2. The screw press liquid separator of claim 1 wherein the positions of the discharge doors are controlled by fluid under pressure; and
the pressure of the fluid is controlled by a feedback loop to maintain current drawn by the motor at a substantially constant value.

3. The screw press liquid separator of claim 2 wherein the fluid under pressure is a gas.

4. The screw press liquid separator of claim 1 wherein an upper guide plate and a lower guide plate are positioned at the top and bottom, respectively, of the discharge end of the screw press between which the opposed pair of discharge doors are pivotally mounted to the sides of the discharge end of the screw press.

5. The screw press liquid separator of claim 1 further comprising a conical wear bushing mounted on the shaft at a location between an end of the screw and the discharge end of the screw press, the diameter of the wear bushing increasing towards the discharge end of the screw press.

6. The screw press liquid separator of claim 5 wherein the diameter of the wear bushing increases at an angle of between about 1° and about 5° over a distance of between 2 inches and 5 inches.

7. The screw press liquid separator of claim 1 wherein the screw cradle is formed from semi-cylindrical halves fastened together.

8. The screw press liquid separator of claim 1 wherein the screw cradle is formed from semi-cylindrical segments fastened together, the semi-cylindrical segments bolted together at end flanges, each semi-cylindrical segment including major ribs, and minor ribs.

9. The screw press liquid separator of claim 8 wherein end flanges at the inlet end and discharge end of the screw cradle are fastened to a frame supporting the housing.

10. The screw press liquid separator of claim 8, wherein the screw cradle is formed from two sections, each section including a pair of semi-cylindrical segments, the semi-cylindrical segments of each section bolted together at end flanges thereof, each semi-cylindrical segment including major ribs, and minor ribs.

11. The screw press liquid separator of claim 1 wherein the screw cradle comprises a plurality of longitudinally oriented evenly spaced apart bars defining slots having a slot width between the bars, the bars each having a width being between about three to about four times the slot width.

12. The screw press of claim 1 wherein the bulk material inlet of the screw cradle communicates with an input hopper disposed at a top of the housing.
